(19) United States
(12) Patent Application Publication
(10) Pub. No.: US 2010/0205736 A1
(43) Pub. Date: Aug. 19, 2010

(54) Sauna apparatus

(76) Inventors: Chung Tai Chang, Tainan (TW); Chia Hao Chang, Tainan (TW)

Correspondence Address: Chung Tai Chang;No. 149, (Room 9, 10/F.), Lin Sen Road, Sec. 1,, Tainan, 701, TW

(21) Appl. No.: 12/378,450

(22) Filed: Feb. 17, 2009

(51) Int. Cl. A61H 33/06

(52) U.S. Cl. 4/527

(57) ABSTRACT

A sauna apparatus is disclosed. The covering cloth of the sauna apparatus has at least a plastic gastight, an insulation and a cladding layers of cloths piled in sequence, followed by combining them into one piece by means of high frequency melting technology, and the covering cloth thus features air barrier and heat preservation which substantially boosts the heat efficiency of the sauna apparatus.

### BACKGROUND OF THE INVENTION

1. Field of the Invention

This invention relates to sauna apparatus and more specifically to a covering cloth, capping a flexible and foldable sustaining frame, where the covering cloth has at least a plastic gastight, an insulation and a cladding layers of cloths piled in sequence, followed by combining them into one piece by means of high frequency melting technology, and the covering cloth thus features air barrier and heat preservation which substantially boosts the heat efficiency of the sauna apparatus.

2. Description of the Prior Art

A “SAUNA DEVICE” (named “prior case” hereinafter) as disclosed in USPTO U.S. Pat. No. 6,615,419, also the ROC Patent No. 563550 is invented and filed by this inventor. The prior case has a structure which is a gastight covering cloth capping a flexible and foldable sustaining frame, where the covering cloth is provided with an opening at its top and a zipper at its front. The chamber shaped by the sustaining frame and the covering cloth is provided with a set of heating apparatus, where the heat generated by the heating apparatus forms perturbation airflow which is uniform in the heat and temperature, enabling someone located in the chamber with the head stretched out from the opening to experience the hot effect on his/her body provided by the sauna. However, the covering cloth of the prior case is made up of a single layer of gastight nylon cloth only. Though it is gastight for preventing the heat from being discharged, the cold air at the exterior of the covering cloth is easy to participate in the transmittal of heat through the gastight PVC cloth, which would lower the temperature of the chamber and make the heating apparatus to keep working to maintain the heat in the chamber. Therefore, the prior case has sizable room for the improvement regarding its heat efficiency. In light of the aforesaid drawbacks, this inventor conceived the idea for the improvement, which eventually gave birth to this invention.

### SUMMARY OF THE INVENTION

The objective of the present invention is to provide a sauna apparatus which is capable of boosting the heat efficiency in the chamber and on the other hand preventing the temperature dropping by means of the rapid transmittal of heat. The major trait of the present invention lies in: the covering cloth has at least a plastic gastight layer, an insulation layer and a cladding layer of cloths piled in sequence, followed by combining them together with high frequency melting technology. And the covering cloth thus features air barrier and heat preservation which substantially boosts the heat efficiency of the sauna apparatus.

### BRIEF DESCRIPTION OF THE DRAWINGS

FIG. 1 is an exterior view of the structure of the exemplified embodiment of the present invention;

FIG. 2 is an interior view of the structure of the exemplified embodiment of the present invention;

FIG. 3 is a figure (I) of the structure of the covering cloth of the exemplified embodiment of the present invention;

FIG. 4 is a figure (II) of the structure of the covering cloth of the exemplified embodiment of the present invention; and

FIG. 5 is a schematic diagram of the packing up of the covering cloth of the exemplified embodiment of the present invention.

### DETAILED DESCRIPTION OF THE INVENTION

To achieve the aforementioned objects and functions of the present invention, the techniques adopted and the structure are detailed described with reference to the following preferred exemplified embodiments and the accompanying drawings:

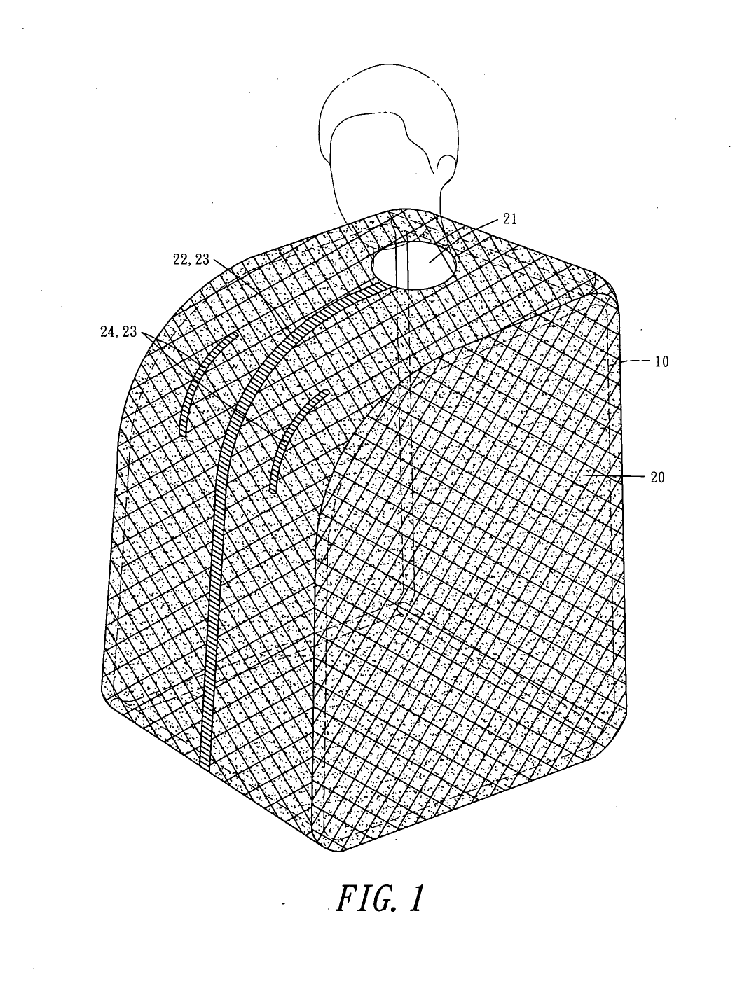

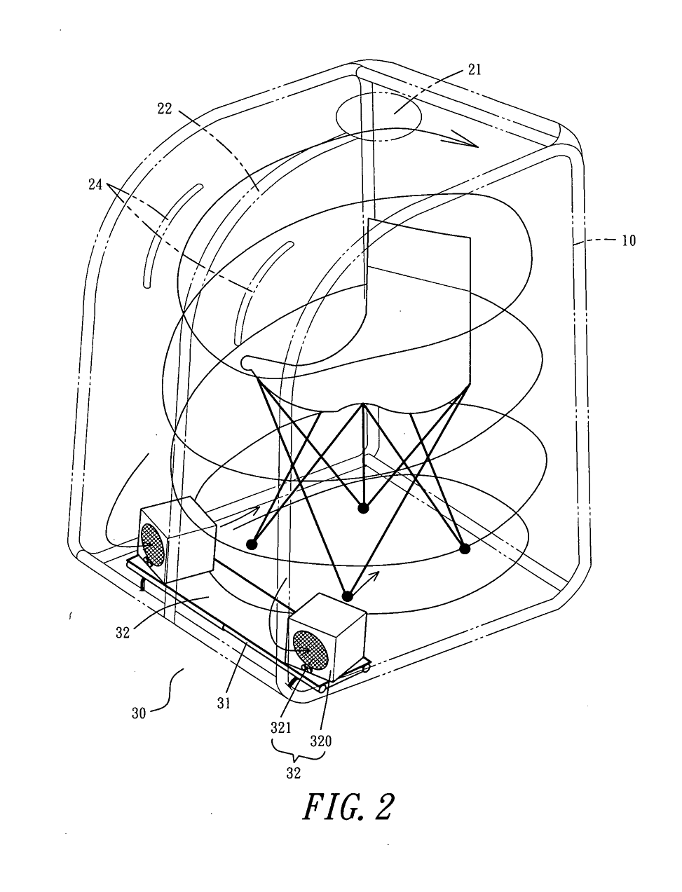

Referring to FIGS. 1 & 2, the sauna apparatus of the exemplified embodiment of the present invention comprises:

a sustaining frame 10, where the frame is made up of flexible tubes, which brings in a foldable outcome.

a covering cloth 20, capping the sustaining frame 10, together with the sustaining frame 10 to form a chamber. An opening 21 is at its top center, and an entrance 22 is at its front middle which extends from the bottom of the covering cloth 20 up to the opening 21, where the entrance 22 is closed by a fastening element 23 (zipper), and a hand hole 24 is located at each side of the entrance 22 which is also closed by the fastening element 23 (zipper). The user of the sauna apparatus may open the fastening element 23 of the entrance 22 to sit in the chamber and close the fastening element 23, where the head of the user stretches out from the opening 21 while the hands are from the hand holes 24.

a heating apparatus 30, located in the chamber formed by the covering cloth 20 and the sustaining frame 10. The heating apparatus 30 is provided with a base 31, where the base 31 can be adjusted in a stretchable manner. The two ends of the base 31 each has a heater 32 fixed at its top, where the heater 32 has a case 320, and the case 320 is provided with a wind entrance 321 at each of its front and back ends. The case 320 is provided with an electric fan and a positive temperature coefficient heat element (PTC heater), which enables the heater 32 to generate hot air circulating in the chamber, to make someone in the chamber enjoy the wonderful heat of the sauna.

The major improvements of this invention lie in:

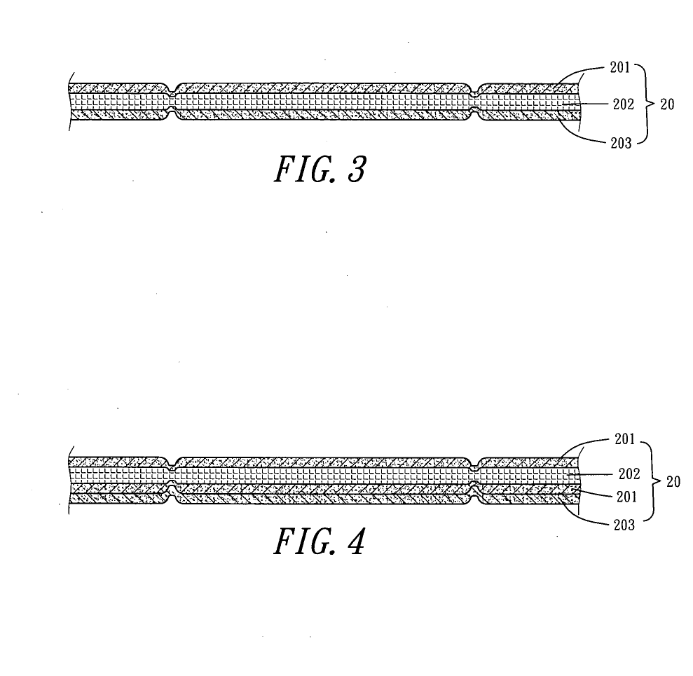

The above covering cloth 20 (referring to FIG. 3), has a plastic gastight layer cloth 201, an insulation layer cloth 202 and a cladding layer cloth 203 piled in sequence, followed by combining them together with high frequency melting technology, wherein,

the gastight layer cloth 201, can be a nylon cloth with POLY glue or PU adhesive or both spread over its surface, enabling the gastight and plastic properties which prevents the hot air in the chamber from being discharged. To colorize the gastight layer cloth 201, color glue (for instance: silver glue) can be spread together with the POLY glue over the surface of the nylon cloth at the same time, to enable the gastight layer cloth 201 to have color, gastight property and heat reflection effect.

the insulation layer cloth 202, can be a polyester padding (a composite cotton made from adding resin during the manufacture of polyester, which features heat preservation and plasticity, and further possesses functions of heat insulation and sustaining the covering cloth 20.

the cladding layer cloth 203, can be obtained by spreading POLY glue or PU glue or both over a chemical fiber cloth (for instance: pongee), which makes the surface artistic, and it could be spread with water repellent for having better waterproof property.

The aforesaid layers of cloths each are provided with plasticity after being piled; therefore, they can be melted by high frequency melting in forming the covering cloth 20. Since the gastight layer cloth 201 is gastight, it prevents the heat in the chamber from being discharged; the insulation layer cloth 202 features heat preservation, which substantially preserves the temperature in the chamber, prevents the exterior cold air from carrying out transmittal of heat, and also sustains the covering cloth 20; the cladding layer cloth 203 features to beautify the surface of the covering cloth 20. The entire layers of the covering cloth 20 are melted together by the high frequency melting, which prevents the heat from being discharged through the thread and the gaps around the needle thread holes on the prior art covering cloths sewn by the sewing machine.

Moreover, referring to FIG. 4, an additional layer of the second gastight layer cloth 201 is placed between the aforementioned insulation layer cloth 202 and the cladding layer cloth 203, for the purpose of separating the cold air exterior to the sauna apparatus by the second gastight layer cloth 201, which sizably boosts the gastight quality of the covering cloth 20.

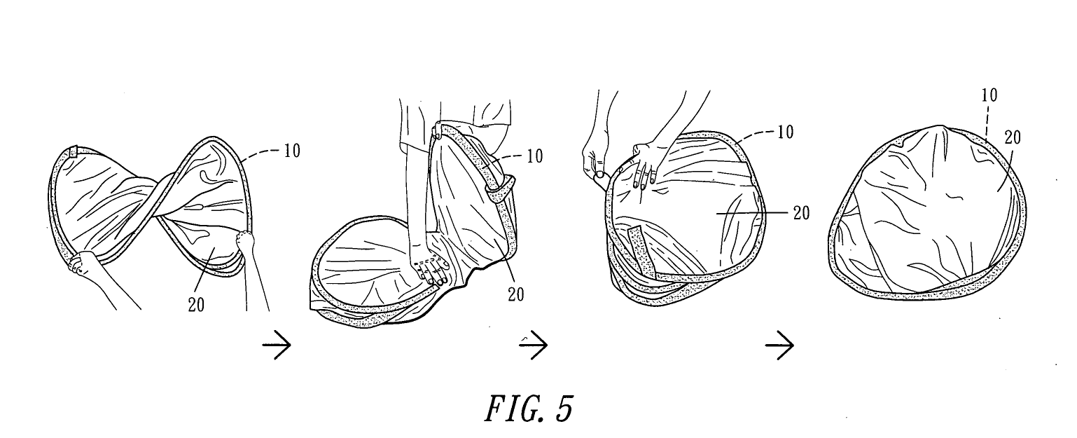

Accordingly, the covering cloth 202 of the present invention has the plastic gastight layer cloth 201, an insulation layer cloth 202 and a cladding layer cloth 203 piled in sequence, followed by combining them together with high frequency melting technology, and the combined covering cloth 20 features air barrier, heat preservation and grace which substantially boosts the heat efficiency of the sauna apparatus. Moreover, the sustaining frame is flexible for folding, which makes the entire covering cloth 20 and the sustaining frame 10 to be folded as in FIG. 5.

In general, this invention is construed to be creative and novel, thereby filing the present application herein subject to the patent law, which deserves your favorable examination and approval.

What is claimed is:

1. A sauna apparatus, comprising:
a.) a sustaining frame, where the frame is made up of flexible tubes;
b.) a covering cloth, capping said sustaining frame, together with said sustaining frame to form a chamber, having an opening at its top center, and being provided with an entrance at its front middle which extends from the bottom of said covering cloth up to the opening, where the entrance is closed by a fastening element;
c.) a heating apparatus, located in the chamber formed by said covering cloth and said sustaining frame, and being provided with a base, where the base has a heater fixed at its top, and the heater having a case, where the case is provided with a wind entrance at each of its front and back ends, and the case being provided with an electric fan and a positive temperature coefficient heat element, which enables the heater to generate hot air circulating in the chamber;
the traits lie in: said covering cloth having a plastic gastight layer cloth, an insulation layer cloth and a cladding layer cloth piled in sequence, followed by combining them together with high frequency melting technology, wherein the gastight layer cloth is a nylon cloth with POLY glue or PU adhesive or both spread over its surface, the insulation layer cloth is a polyester padding and the cladding layer cloth is obtained by spreading POLY glue or PU glue or both over a chemical fiber cloth.

2. The sauna apparatus as in claim 1 wherein an additional layer of the second gastight layer cloth is placed between the insulation layer cloth and the cladding layer cloth.

3. The sauna apparatus as in claim 1 wherein the chemical fiber cloth used for the cladding layer cloth is pongee.

4. The sauna apparatus as in claim 1 wherein the cladding layer cloth is spread with water repellent at its surface.
